(19) United States
(12) Patent Application Publication
(10) Pub. No.: US 2009/0208783 A1
(43) Pub. Date: Aug. 20, 2009

(54) Low porosity anode diffusion media for fuel cells

(76) Inventors: Yongjun Leng, State College, PA (US); Chao-Yang Wang, State College, PA (US); Takashi Akiyama, Osaka (JP)

Correspondence Address: MCDERMOTT WILL & EMERY LLP, 600 13TH STREET, N.W., WASHINGTON, DC, 20005-3096, US

(21) Appl. No.: 12/071,155

(22) Filed: Feb. 15, 2008

(51) Int. Cl. H01M 8/02

(52) U.S. Cl. 429/13; 429/12

(57) ABSTRACT

A direct oxidation fuel cell (DOFC) having a concentrated liquid fuel and an anode electrode configured to generate power. The anode electrode includes a diffusion medium (DM) with or without a microporous layer, such that a decrease in the porosity of the DM reduces fuel crossover through the membrane and achieves high power density of the DOFC fed directly with concentrated fuel.

### FIELD OF THE DISCLOSURE

The present disclosure relates generally to fuel cells, fuel cell systems, and electrodes/electrode assemblies for the same. More specifically, the present disclosure relates to anodes with improved diffusion media, suitable for direct oxidation fuel cells (hereinafter “DOFC”), such as direct methanol fuel cells (hereinafter “DMFC”), and their components.

### BACKGROUND OF THE DISCLOSURE

A DOFC is an electrochemical device that generates electricity from electrochemical oxidation of a liquid fuel. DOFC's do not require a preliminary fuel processing stage; hence, they offer considerable weight and space advantages over indirect fuel cells, i.e., cells requiring preliminary fuel processing. Liquid fuels of interest for use in DOFC's include methanol, formic acid, dimethyl ether, etc., and their aqueous solutions. The oxidant may be substantially pure oxygen or a dilute stream of oxygen, such as that in air. Significant advantages of employing a DOFC in portable and mobile applications (e.g., notebook computers, mobile phones, personal data assistants, etc.) include easy storage/handling and high energy density of the liquid fuel.

One example of a DOFC system is a direct methanol fuel cell, (DMFC). A DMFC generally employs a membrane-electrode assembly (hereinafter “MEA”) having an anode, a cathode, and a proton-conducting membrane electrolyte positioned therebetween. In the MEA, a catalyst layer is usually supported on a diffusion medium (DM) that is made of either a carbon cloth, carbon paper, porous carbon or porous metals. The microporous layers (MPL), may be placed between the catalyst layer and DM, is intended to provide wicking of liquid water into the DM, minimize electric contact resistance with the adjacent catalyst layer, and furthermore prevent the catalyst layer from leaking into the DM, thereby increasing the catalyst utilization and reducing the tendency of electrode flooding.

A typical example of a membrane electrolyte is one composed of a perfluorosulfonic acid-tetrafluorethylene copolymer, such as NAFION® (NAFION® is a registered trademark of E.I. Dupont de Nemours and Company). In a DOFC, an alcohol/water solution is directly supplied to the anode as the fuel and air is supplied to the cathode as the oxidant. At the anode, the alcohol, such as methanol reacts with water in the presence of a catalyst, typically a Pt or Ru metal-based catalyst, to produce carbon dioxide, H⁺ ions (protons), and electrons. The electrochemical reaction is shown as equation (1) below:

CH₃OH+H₂O→CO₂+6H⁺+6e⁻ (1)

During operation of the DOFC, the protons migrate to the cathode through the proton-conducting membrane electrolyte, which is non-conductive to electrons. The electrons travel to the cathode through an external circuit for delivery of electrical power to a load device. At the cathode, the protons, electrons, and oxygen molecules, typically derived from air, are combined to form water. The electrochemical reaction is given in equation (2) below:

3/2O₂+6H⁺+6e⁻→3H₂O (2)

Electrochemical reactions (1) and (2) form an overall cell reaction as shown in equation (3) below:

CH₃OH+ 3/2O₂→CO₂+2H₂O (3)

One drawback of a conventional DOFC is that the alcohol, such as methanol, partly permeates the membrane electrolyte from the anode to the cathode, such permeated methanol being termed “crossover methanol”. The crossover methanol reacts with oxygen at the cathode, causing a reduction in fuel utilization and cathode potential, with a corresponding reduction in power generation of the fuel cell. It is thus conventional for DOFC systems, to use excessively dilute (3-6% by vol.) alcohol solutions for the anode reaction in order to limit crossover and its detrimental consequences. However, the problem with such a DOFC system is that it requires a significant amount of water to be carried in a portable system, thus diminishing the system energy density.

The ability to use highly concentrated fuel is desirable for portable power sources, particularly since DOFC technology is currently competing with advanced batteries, such as those based upon lithium-ion technology. Therefore it is necessary to reduce methanol crossover from the anode to the cathode. There are several methods to reduce methanol crossover: (1) develop alternative proton conducting membranes with low methanol permeability, (see, N. W. Deluca and Y. A. Elabd, Polymer electrolyte membranes for the direct methanol fuel cell: A review, Journal of Polymer Science: Part B: Polymer Physics, 44, pp. 2201-2225, 2006 and V. Neburchilov, J. Martin, H. J. Wang, J. J. Zhang, A Review of Polymer Electrolyte Membranes for Direct Methanol Fuel Cells, Journal of Power Sources, 169, pp. 221-238, 2007); (2) modify the existing membrane like NAFION® by making it a composite with inorganic and organic materials, or by executing the membrane surface modification, (see Deluca et al., and Neburchilov et al.); (3) control the mass transport in the anode through a porous carbon plate. (See M. A. Abdelkareem and N. Nakagawa, DMFC employing a porous plate for an efficient operation at high methanol concentrations, Journal of Power Sources, 162, pp. 114-123, 2006).

However, the above-mentioned methods have certain disadvantages. In Method (1), low proton conductivity of alternative polymer electrolyte membranes and low compatibility/adhesion with NAFION®-bonded electrodes limit the attainment of high power density. In Method (2), modification of NAFION® membrane may lead to the decrease of proton conductivity and stability. In Method (3), the addition of porous carbon plate increases the thickness of each unit cell and hence increases the stack volume; and it likely increases the manufacturing cost of a DMFC system.

In view of the foregoing, there exists a need for improved DOFC/DMFC systems including an anode diffusion medium (DM), which facilitates a reduction of methanol crossover.

### SUMMARY OF THE DISCLOSURE

An advantage of the present disclosure is a fuel cell having reduced fuel crossover from the anode to cathode and in particular a fuel cell having a reduced alcohol crossover.

Embodiments of the disclosure include a direct methanol fuel cell having an anode diffusion medium with a reduced porosity to minimize alcohol transport and crossover rates.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The various features and advantages of the present disclosure will become more apparent and facilitated by reference to the accompanying drawings, provided for purposes of illustration only and not to limit the scope of the invention, wherein the same reference numerals are employed throughout for designating like features and the various features are not necessarily drawn to scale but rather are drawn as to best illustrate the pertinent features.

The drawings disclose illustrative embodiments. They do not set forth all embodiments. Other embodiments may be used in addition or instead. Details that may be apparent or unnecessary may be omitted to save space or for more effective illustration. Conversely, some embodiments may be practiced without all of the details that are disclosed, wherein:

FIG. 1. is a graph showing the relationship between the porosity of FEP treated carbon paper and the FEP content;

FIG. 2. is a graph showing methanol crossover under open-circuit condition of MEA at 70° C. with the base case and modified anode DM when fed with 4M methanol;

FIG. 3. is a graph showing methanol crossover under open-circuit condition of MEA at 65° C. as a function of porosity of anode DM;

FIG. 4. is a graph of IR-free anode polarization at 70° C. as a function of current density with the base case and modified anode DM when fed with 4M methanol;

FIG. 5. is a graph showing Steady-state performance discharged at 250 mA/cm² of DMFC with the base case and modified anode DM when fed with 4M methanol (Operating conditions: T=70° C., 4M, ξₐ/ξ_{c}=1.67/3@250 mA/cm²);

FIG. 6. is a graph showing Steady-state performance of DMFC with the modified anode DM when fed with 6M at 65° C. and with 8M methanol at 60° C.

### DETAILED DESCRIPTION OF THE DISCLOSURE

Illustrative embodiments are now discussed. Other embodiments may be used in addition or instead. Details that may be apparent or unnecessary may be omitted to save space or for a more effective presentation. Conversely, some embodiments may be practiced without all of the details that are disclosed

The crossover of a fuel in a direct oxidation fuel cell can depend on several factors. For example, alcohol crossover depends on such factors as alcohol concentration fed into the anode, operating temperature, alcohol permeability through anode diffusion media, thickness of anode diffusion media, and alcohol permeability through the membrane. A method proposed here is to reduce the alcohol crossover via the control of the mass permeability through the anode diffusion media. The alcohol permeation flux through the anode diffusion media depends on the effective mass diffusivity and the feed alcohol concentration, where the effective diffusivity is a function of porosity and tortuosity of anode diffusion media, as shown in Eq. (4),

D^{eff}=εⁿD (4)

where D^{eff} is the effective mass diffusivity, ε the porosity of anode diffusion media, D the alcohol molecular diffusivity, and n the Bruggmann factor to account for the tortuosity effect. In general, a low-porosity anode diffusion medium (DM) reduces the alcohol transport from the feed to the anode catalyst layer, thereby limiting alcohol crossover. Typically, the DM of a DOFC is about 78% porous. Hence, as used herein, a diffusion medium with a reduced or low porosity is one that is less than 78% porous.

In an embodiment of the disclosure the porosity of the DM is between 0.70 to 0.10. In a preferred embodiment of the disclosure the porosity of the DM is between about 0.57 to 0.10.

The low porosity anode diffusion media can be obtained via the following methods, but not limiting to: Filling currently available carbon paper or carbon cloth with polymers such as Polytetrafluorethylene (PTFE), using other diffusion media inherently of low porosity, such as porous carbon, and using metal foams with the controlled porosity.

Furthermore the anode DM may be configured with or without a microporous layer (MPL), which may provide additional resistance to alcohol transport.

Moreover, DM may have a thickness of less than 1000 micrometers, preferably less than 600 micrometers, and most preferably between 300 and 600 micrometers.

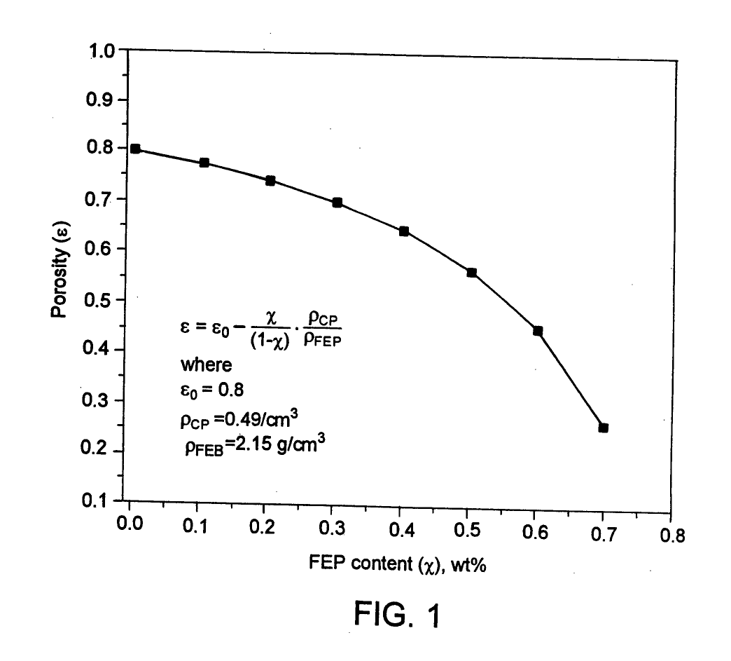

In this disclosure, carbon paper diffusion medium is used as an example to describe how using low-porosity anode diffusion media can significantly reduce alcohol crossover through the membrane. These methods and concepts can also be applied to other types of diffusion media. The carbon paper with different porosity can be obtained by treating the carbon paper with different loading of fluorinated ethylene polymers, for example fluorinated ethylene propylene (FEP). The carbon paper porosity level depends on the weight fraction of the treated transparent exopolymer particles (TEP) in the carbon paper according to the following equation,

$$ɛ = {ɛ}_{0} - \frac{χ}{( 1 - χ )} \cdot \frac{{ρ}_{CP}}{{ρ}_{FEP}} \qquad ( 2 )$$

where ε is the porosity of a FEP-treated carbon paper, ε₀ is the porosity of the untreated carbon paper, χ is the weight fraction of FEP in the carbon paper, ρ_{CP} is the density of the carbon paper, and ρ_{FEP} is the density of the dry FEP. FIG. 1 shows the relationship between the porosity of FEP-treated Toray TGPH-90 carbon paper and the weight fraction of dry FEP.

FIG. 1 shows that the high loading of FEP filled into carbon paper reduces the porosity of the carbon paper. The porosity of 10 wt %, 30 wt %, 50 wt % and 70 wt % FEP-treated Toray TGPH-90 carbon papers are 0.78, 0.70, 0.57 and 0.27 respectively. In this disclosure, two methods are described to reduce alcohol permeability through DM: one is to increase the thickness of anode diffusion media, and another is to reduce the pore size/porosity of anode diffusion media. In case 1, two pieces of 30 wt % FEP-treated TGPH-90 Toray carbon paper (ε=0.70) is used as the anode DM.

In case 2, one piece of 50 wt % FEP-treated TGPH-90 Toray carbon paper (ε=0.57) is used. In case 3, one piece of 70 wt % FEP-treated TGPH-90 Toray carbon paper (ε=0.27) is used. In Cases 2 and 3, the high loading of treatment agents is used to reduce the porosity of the DM. As a result, a large resistance to alcohol transport is created in the DM.

The DM in the base case is 10 wt % FEP-treated TGPH-90 Toray carbon paper (ε=0.78), which is optimal for the DMFC fed with 1 molar (M) or 2M methanol solution due to the balance between sufficient mass transport of methanol through the anode diffusion media and reasonable methanol crossover.

The carbon papers were treated with fluorinated ethylene propylene (FEP) as follows. The carbon paper was slowly dipped into a 20 wt % FEP suspension, then was dried at 80° C. in the oven. The procedure was repeated until the desired loading of the FEP (10 wt %, 30 wt %, 50 wt % and 70 wt %) was achieved. The FEP-impregnated carbon paper was heat-treated at 270° C. for 10 min and sintered at 340° C. for 30 min. A paste for making desirable microporous layers (MPL) was made by mixing carbon powder (for example, Vulcan XC-72R) and 60 wt % PTFE suspension, iso-propanol and de-ionized water. The paste was cast onto the surface of carbon paper to form a microporous layer. The coated carbon paper was dried at 100° C. for 1 h and sintered at 360° C. for 30 min. Details of MEA fabrication procedure are similar to that described in previous patents and/or publications, (see U.S. patent application Ser. No. 11/655,867), except for the 30 wt %, 50 wt % and 70 wt % FEP-treated carbon paper used as the anode DM.

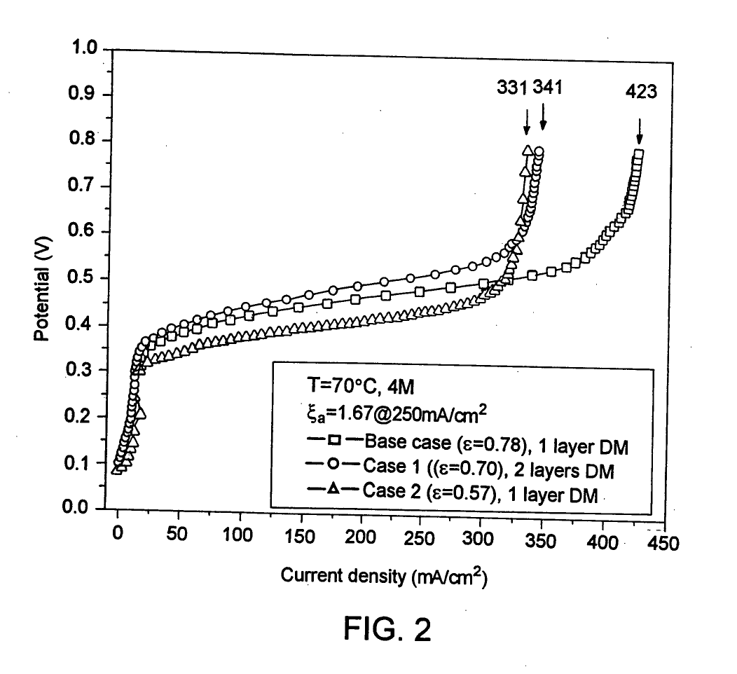

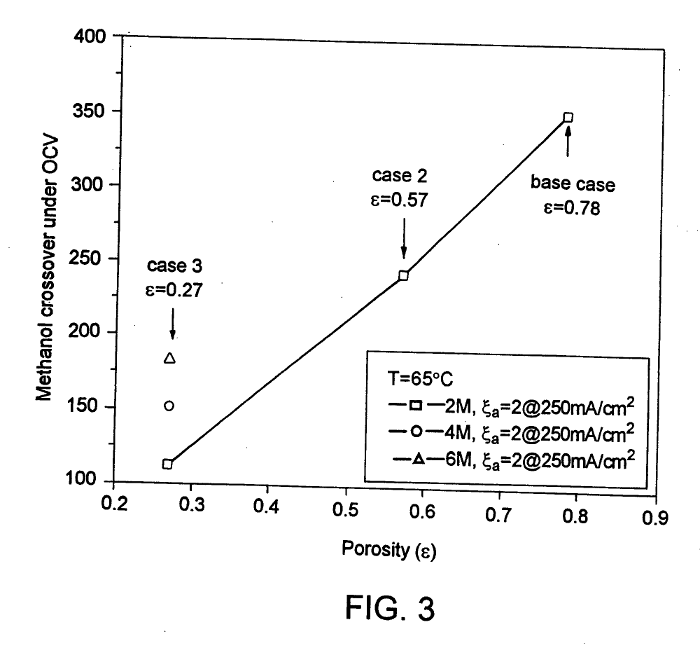

In comparison with the results obtained with the base case DM, the MEA with the modified DM in Cases 1 and 2 shows 19% and 22% reduction in methanol crossover under open-circuit condition when fed with 4 molar (M) methanol (see FIG. 2), respectively. This indicates that increasing thickness of the anode diffusion media (from one layer to two layers of Toray TGPH-90 carbon paper with a porosity of 0.70) and decreasing the porosity of the anode diffusion media (one layer DM with a porosity reduced from 0.78 to 0.57) can significantly reduce methanol crossover through the membrane. As shown in FIG. 3, methanol crossover decreases with decreasing of the porosity of anode DM.

When the porosity of the anode diffusion media is extremely low, such as 0.27 in Case 3, the methanol crossover through the membrane under open-circuit condition is very small. When fed with 2M methanol, the methanol crossover under open-circuit condition in Case 3 (ε=0.27) is only 32% of that exhibited in the base case (ε=0.78), and about half of that exhibited in Case 2 (ε=0.57). Even when fed with 6M, the methanol crossover under open-circuit condition in Case 3 is less than half of when fed with 2M in the base case. Therefore, low porosity anode diffusion media was found to be very effective to reduce methanol crossover through the membrane.

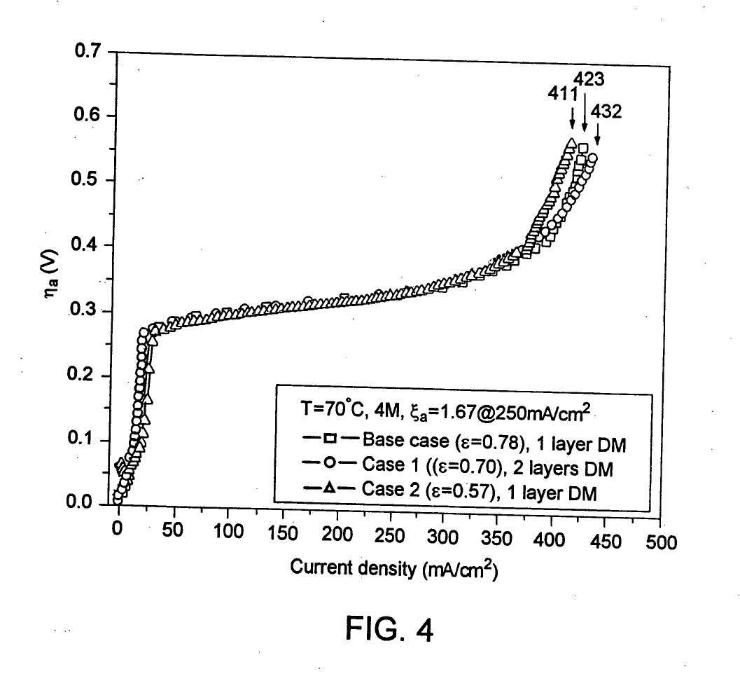

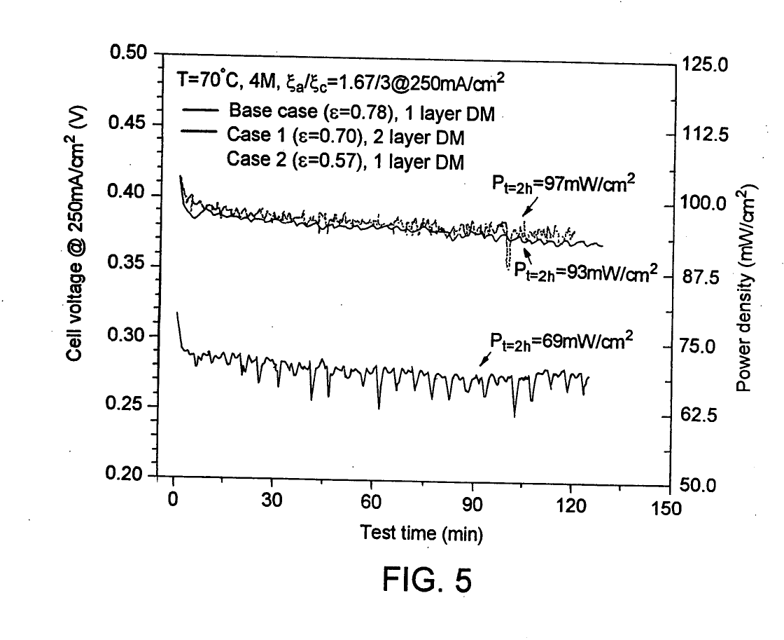

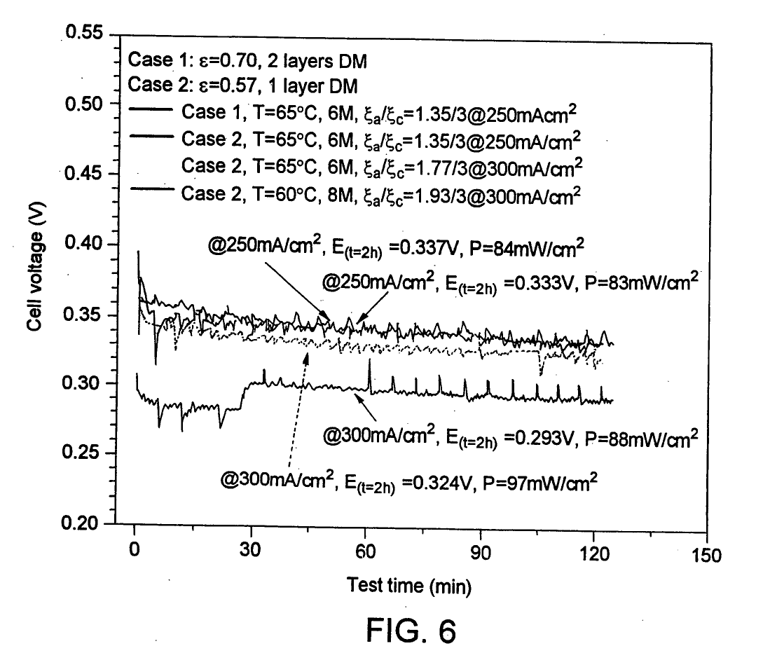

While fed with a fuel of 4M methanol, the iR-free anode overpotential in modified cases (Cases 1 and 2) is almost the same as that in the base case (FIG. 4). Low methanol crossover in the modified cases (Cases 1 and 2) increases fuel efficiency, and mitigates the effect of mixed potential at the cathode side. Therefore, there is a marked improvement in power density in case of MEA with the modified DMs. As shown in FIG. 5, the power density of the modified cases (Cases 1 and 2) can reach 93˜97 mW/cm² at 70° C., 35˜40% higher than that achieved in the base case. As used herein, a concentrated fuel is one which is at least 2 molar (M) in concentration and a highly concentrated fuel is one which is at least 4M in concentration. In addition, DMFC with the modified DMs (Cases 1 and 2) can achieve high power even when fed with high concentration methanol fuel such as 6M and 8M methanol. As shown in FIG. 6, the highest power densities that can be reached are 97 and 88 mW/cm² when fed with 6M at 65° C. and 8M methanol at 60° C., respectively.

In summary, the present disclosure describes low-porosity anode diffusion media for use in DMFC systems, which facilitates operation at good power densities with highly concentrated fuel.

In the previous description, numerous specific details are set forth, such as specific materials, structures, reactants, processes, etc., in order to provide a better understanding of the present disclosure. However, the present disclosure can be practiced without resorting to the details specifically set forth. In other instances, well-known processing materials and techniques have not been described in detail in order not to unnecessarily obscure the present disclosure.

Only the preferred embodiments of the present disclosure and but a few examples of its versatility are shown and described in the present disclosure. It is to be understood that the present disclosure is capable of use in various other combinations and environments and is susceptible of changes and/or modifications within the scope of the disclosed concept as expressed herein.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

The phrase “means for” when used in a claim embraces the corresponding structures and materials that have been described and their equivalents. Similarly, the phrase “step for” when used in a claim embraces the corresponding acts that have been described and their equivalents. The absence of these phrases means that the claim is not limited to any of the corresponding structures, materials, or acts or to their equivalents.

Nothing that has been stated or illustrated is intended to cause a dedication of any component, step, feature, object, benefit, advantage, or equivalent to the public, regardless of whether it is recited in the claims.

In short, the scope of protection is limited solely by the claims that now follow. That scope is intended to be as broad as is reasonably consistent with the language that is used in the claims and to encompass all structural and functional equivalents

What is claimed is:

1. A direct oxidation fuel cell (DOFC) comprising:
a liquid fuel, an anode electrode configured to generate power, the anode electrode having a diffusion medium (DM) with or without a microporous layer;
wherein the DM has a low porosity such that it reduces fuel crossover through the membrane and increases the power density of the DOFC under highly concentrated fuel.

2. The DOFC of claim 1, wherein the DM porosity is between 0.70 and 0.10.

3. The DOFC of claim 2, wherein the DM porosity is between about 0.57 and 0.10.

4. The DOFC of claim 1, wherein the DM is loaded with at least one fluorinated polymer to achieve a reduction in porosity.

5. The DOFC of claim 4, wherein the DM is loaded at between 30 wt % to 70 wt % with said at least one fluorinated polymer.

6. The DOFC of claim 4 wherein at least one of said fluorinated polymer is fluorinated ethylene propylene.

7. The DOFC of claim 1, wherein the DM thickness is less than 600 micrometers.

8. The DOFC of claim 7, wherein the DM thickness is between 300 and 600 micrometers.

9. The DOFC of claim 1, wherein said highly concentrated liquid fuel is at least 4 molar (M) in concentration.

10. The DOFC of claim 1, wherein said highly concentrated liquid fuel is methanol.

11. The DOFC of claim 10, wherein said highly concentrated methanol is at least 4 molar (M) in concentration.

12. An anode electrode configured to be used in a direct oxidation fuel cell (DOFC), the anode electrode comprising a diffusion medium (DM) with or without a microporous layer,
wherein said DM has a low porosity such that it reduces fuel crossover through the membrane and increases the power density of the DOFC.

13. The anode electrode of claim 12, wherein the porosity of said DM is reduced by loading said DM with at least one fluorinated polymer.

14. The anode of claim 13, wherein said DM is loaded at 30 wt % to 70 wt % with at least one of said one or more fluorinated polymer.

15. The anode electrode of claim 13, wherein at least one of said fluorinated polymer is fluorinated ethylene propylene.

16. The anode of claim 12, wherein said DM comprises carbon paper, carbon cloth, porous carbon, or porous metals.

17. The anode of claim 12, wherein said microporous layer is prepared from carbon powder and Polytetrafluorethylene (PTFE) suspension.

18. The anode of claim 12, wherein the porosity of said DM layer is less than 0.78.

19. The anode of claim 18, wherein the porosity of said DM layer is between 0.70 and 0.10.

20. The anode of claim 19, wherein the porosity of said DM layer is between about 0.57 and 0.10.

21. A method of operating a direct oxidation fuel cell (DMFC) system, comprising steps of:
(a) providing at least one fuel cell assembly including a cathode and an anode with an electrolyte positioned therebetween, said anode comprising a diffusion medium (DM) with or without a microporous layer, said DM comprising an electrically conductive material and a fluorinated polymer;
b) loading said DM with said fluorinated polymer in the range from about 10 to about 70 wt %;
c) supplying a concentrated solution of a liquid fuel and water to said anode; and
d) operating said at least one fuel cell assembly with low methanol crossover and high power density.
